(19) United States
(12) Patent Application Publication
(10) Pub. No.: US 2025/0381742 A1
(43) Pub. Date: Dec. 18, 2025

(54) Taping Device And Method Using Heated Gas

(71) Applicants: H2EVO Tech LLC, Northville, MI (US); WAL Fuel Systems USA Inc., Livonia, MI (US)

(72) Inventors: Xiankai Song, Livonia, MI (US); Sami Siddiqui, Livonia, MI (US); Kuiwen Zhang, Livonia, MI (US)

(21) Appl. No.: 18/747,031

(22) Filed: Jun. 18, 2024

(51) Int. Cl. B29C 70/38; B29C 70/54

(52) U.S. Cl. CPC B29C 70/388; B29C 70/54

(57) ABSTRACT

Taping devices and methods for consolidating or bonding a reinforced tape to a mandrel or substrate using heated gas to form a composite component are disclosed. In one example the tape is a unidirectional tape and the heated gas is nitrogen gas which is efficient to heat the tape and reduces or eliminates oxidation of the heated tape at the time of consolidation. In one example, the unidirectional tape is a thermoplastic unidirectional tape. In one example, the taping device is used with a compression compensation device to counteract at least a portion of a compressive force applied to the mandrel by a compression roller.

### TECHNICAL FIELD

The present disclosure relates generally to the field of composite manufacturing of components. The disclosure is applicable to, but is not limited to, commercial unidirectional tape winding and tape lamination processes used to manufacture composite components.

### BACKGROUND

The manufacture of composite components has included tape winding and tape laying or lamination processes. In tape winding, often several layers of reinforced tape are sequentially wound around a cylindrical mandrel or substrate. In tape laying, often several sequential layers of reinforced tape are applied atop one another over a large panel or substrate and heat is applied to form a laminated layer of composite material covering the panel.

Conventional tape winding and tape laying processes have commonly used thermoset tape which has disadvantages of slow production speeds and environmental concerns. Thermoplastic tape has been used, but has conventionally employed lasers or infrared (IR) heaters to heat the tape to form a composite reinforcing structure. The use of lasers is disadvantageous from a cost perspective. The use of IR is disadvantageous as oxidation of the polymer tape may occur.

The present invention improves on or eliminates the disadvantages of the conventional tape winding and tape laying materials and processes.

### SUMMARY

In one example of the disclosure, a taping device includes a tape reel configured to dispense a tape. A compression roller is positioned downstream of the tape reel and is configured to apply a compressive force to the tape at a contact region to consolidate the tape to a mandrel. A nozzle is configured to direct a heated gas into an area encompassing a portion of a tape path of travel upstream of the contact region to heat the tape prior to application of the compressive force.

In one example of the taping device, the tape is a unidirectional tape having reinforcing fibers embedded in the tape oriented parallel to the tape path of travel. In another example, the unidirectional tape is a thermoplastic unidirectional tape. In another example, the heated gas is nitrogen gas.

In another example of the disclosure, a unidirectional taping device includes a tape reel configured to dispense a thermoplastic unidirectional tape having a width and including reinforcing fibers embedded in the thermoplastic unidirectional tape oriented parallel to a tape path of travel. A compression roller is positioned downstream of the tape reel along the tape path of travel and is configured to apply a compressive force to the tape at a contact region to consolidate the tape with a mandrel. A nozzle is configured to direct heated gas into an area encompassing a portion of the tape path of travel upstream of the contact region to heat the tape prior to application of the compressive force. The area encompassing the tape path of travel including an area width 5-10 millimeters (mm) wider than the width of the thermoplastic unidirectional tape and an area length of 10-20 millimeters (mm). A shield is configured to concentrate the heated gas in the area width and the area length. A heater is positioned upstream of the contact region and is configured to heat at least one of the mandrel prior to application of the compressive force to the thermoplastic unidirectional tape at the contact region or a layer of the thermoplastic unidirectional tape previously consolidated with the mandrel prior to application of the compressive force to a successive layer of the thermoplastic unidirectional tape received from the tape reel and configured to be applied over the layer of thermoplastic unidirectional tape previously consolidated with the mandrel.

In one example of the unidirectional taping device, the heated gas is nitrogen gas.

In another example of the disclosure, a compression compensation device is for use in a taping process. The compression compensation device includes a mandrel having an outer wall including an outer surface and an inner surface defining an interior cavity. A compression element is positioned in the interior cavity in abutting contact with the inner surface of the outer wall, the compression element comprising a ferrous material. A compression roller is configured to apply a compressive force on the outer surface of the outer wall. The compression roller further comprising a magnet in magnetic communication with the compression element. The magnet is configured to apply a magnetic attractive force to the compression element generating a reaction compression force by the compression element on the inner surface of the outer wall to counteract at least a portion of the compressive force of the compression roller on the outer surface of the outer wall of the mandrel.

### BRIEF DESCRIPTION OF THE DRAWINGS

FIG. 1 is a schematic end view of one example of a taping device shown in an exemplary tape winding application.

FIG. 2 is a schematic end view of an alternate example of a taping device shown in an exemplary tape winding application.

FIG. 3 is a schematic end view of an alternate example of a taping device shown in an exemplary tape laying application.

FIG. 4 is a schematic, rotated partial top view of the taping device in FIG. 1.

FIG. 5 is a schematic front view of one example of a tape head shown in an exemplary tape laying application.

FIG. 6 is a schematic front view of an alternate example of a tape head shown in an exemplary tape winding application.

FIG. 7 is a schematic right side view of the taping head shown in FIG. 5.

FIG. 8 is a schematic flow chart of one example of a method of consolidating a unidirectional tape.

FIG. 9 is a schematic perspective view of one example of a compression compensation device shown in an exemplary tape winding application.

FIG. 10 is a partial cross-sectional view taken along line 10-10 in FIG. 9.

### DETAILED DESCRIPTION

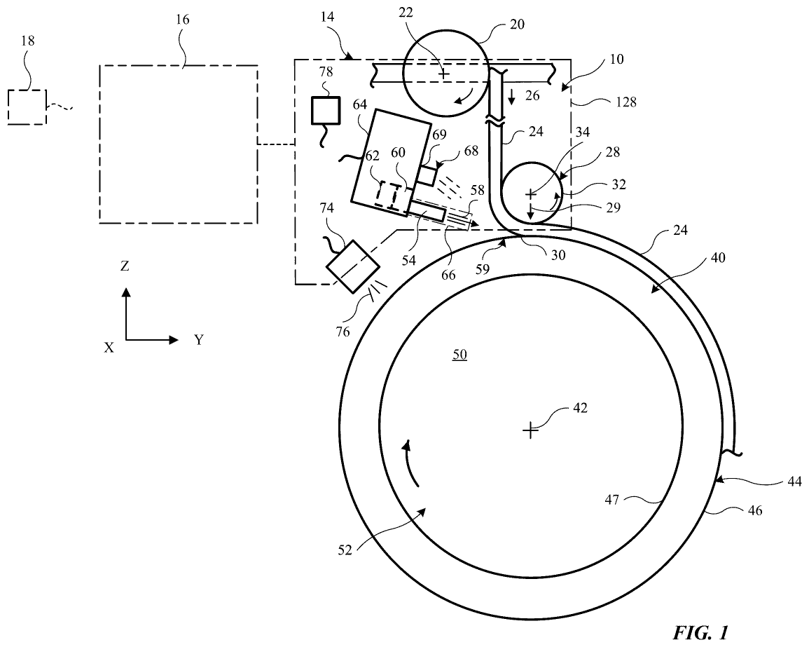

Referring to FIGS. 1-10 several examples of tapings devices, methods of consolidating a unidirectional tape, and a compression consolidation device for use in a taping process are disclosed. The disclosed taping devices, method of consolidation of a unidirectional tape, and the compression consolidation device are useful in tape winding and tape laying or lamination processes or applications for reinforcing a mandrel, a panel and/or a substrate, but are not limited to those applications.

Referring to FIG. 1, a taping device 10 is shown in an exemplary tape winding application. In the example, the taping device 10 includes a tape head 14 which includes several components discussed further below. In one example of an tape head 14 that is part of an automated taping process, the tape head 14 is connected to an actuator 16, for example a programmable, multi-axis robot, that is capable of moving the taping head 14 in the X direction, Y direction, Z direction, and rotation about each of the X direction, Y direction, and Z direction (i.e., six degrees of freedom). In one example, the tape head 14 is connected to a wrist or an end effector (not shown) of the actuator 16 and may be stationary or move relative to the wrist of the robot.

The actuator 16 is in communication with a control system 18 that provides signals and/or instructions to the actuator 16 to move the actuator 16 and the connected tape head 14 according to preprogrammed instructions. The control system 18 may include a computer or other types of computing devices including one or more central processing units (CPU), a memory storage device, one or more controllers, input and output devices, an operating system, and software suitable for the particular application. Other forms or devices of actuator 16 and the control system 18 may be used to suit the particular application as known by persons skilled in the art.

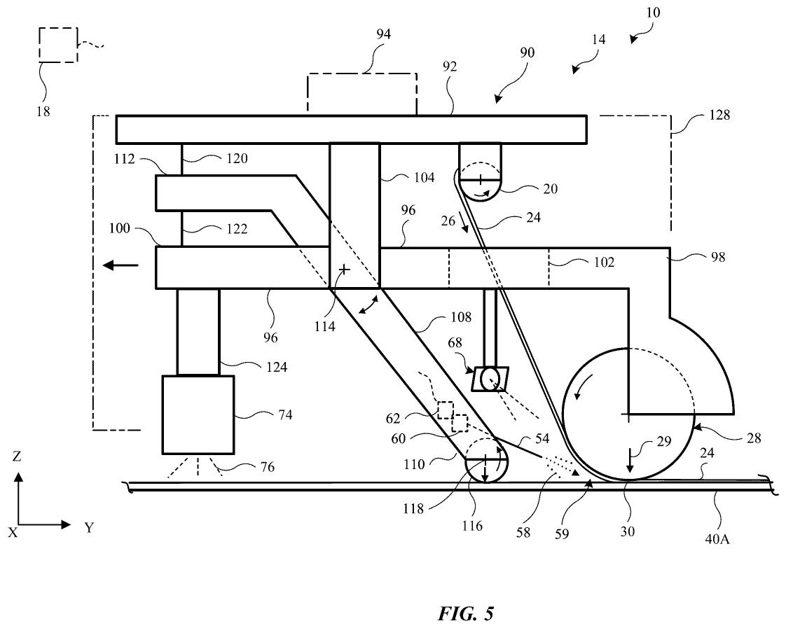

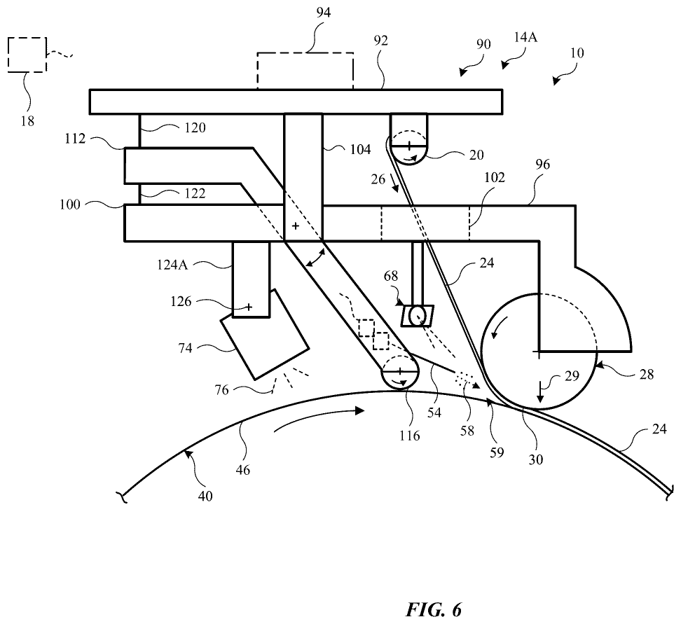

Still referring to the FIG. 1 example, the taping device 10 includes a tape reel 20 configured to rotate about an axis 22 to dispense a tape 24. In one example, the tape reel 20 is configured to receive and rotatably secure a roll or cartridge of the tape 24 that is fed or sequentially metered out from the tape reel 20 as needed during a taping process as further described below. In one example, the tape reel 20 is rotatably connected to, and forms part of, the tape head 14 as shown in FIGS. 1-3 and 5-7. In one example shown in FIGS. 5 and 6 discussed further below, the tape reel 20 may be connected to and supported by a frame internal to the tape head 14 and is configured to rotate about axis 22 to dispense the tape 24. The taping device 10 may include an actuator (not shown) to rotate the tape reel 20 to dispense the tape 24.

In an alternate example (not shown) the tape reel 20 may not form part of the tape head 14. For example, the tape reel 20 may be stationary relative to a workstation and feed the tape 24 as needed to the tape head 14. In an alternate example, the tape reel 20 may be connected to a separate device (not shown) that moves relative to the workstation and/or follows or generally tracks the movements of the tape head 14 to feed or meter out the tape 24 as needed to the tape head 14. Although disclosed as a rotatable reel, the tape reel 20 can take other forms, devices, and configurations capable of dispensing the tape 24 to the tape head 14 or other components of the taping device 10 as needed and as described herein.

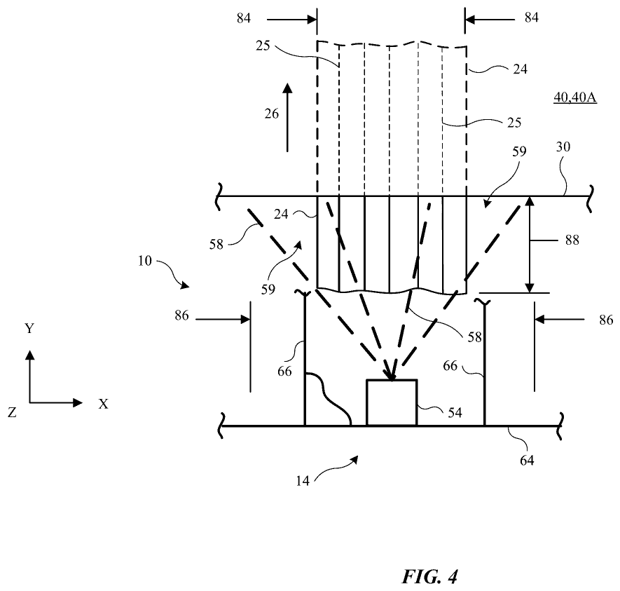

As best seen in FIG. 4, in one example, tape 24 is a unidirectional tape having reinforcing fibers 25 embedded or impregnated in the tape (e.g., in the base material, resin, or polymer matrix of the tape 24) and oriented parallel to a tape path of travel 26. The reinforcing fibers 25 may be made from glass fiber, carbon fiber, polyester, or other materials, and the fibers may be short, long, or continuous to suit the particular application and performance specifications. In an alternate example, the reinforcing fibers 25 may be configured in an aligned orientation that is not in the direction of the tape path of travel 26. In an alternate example, the reinforcing fibers 25 may be configured in a non-unidirectional way, for example randomly oriented or dispersed in the tape. In an alternate example, the reinforcing of the tape 24 may include reinforcing materials other than fibers. In an alternate example, the tape 24 may not include reinforcing fibers 25 or other reinforcing materials.

In one example, the tape 24 is a thermoplastic unidirectional tape wherein the tape (e.g., the base material or resin) is made from polyethylene, polypropylene, nylon, polyether ether ketone (PEEK), polyamide, or other materials suitable for the particular application or performance specifications as known by persons skilled in the art. In an alternate example, the tape 24 may be made from materials or compositions other than thermoplastic materials, for example, thermoset materials. Other forms, materials, or composition polymers may be used to suit the application or performance specifications as know by persons skilled in the art.

Still referring to the FIG. 1 example, the taping device 10 includes a compression roller 28 (e.g., a consolidation roller) positioned downstream of the tape reel 20 and is configured to apply a compressive force 29 to the tape 24 at a contact region 30 as further described below. The compression roller 28 is a round or cylindrically-shaped member having an outer surface 32 and rotates about an axis 34. The compression roller 28 may be powered by an actuator (not shown) or may be an idler roller (not powered). The compression roller 28 may be made from steel or other rigid materials. The compression roller 28 may take other forms, configurations, shapes, sizes, dimensions and be made from other materials to suit the particular application and performance specifications as known by persons skilled in the art.

In one example as shown in FIGS. 1-3, 5 and 6, the compression roller 28 is a part of, or is included in, an assembly of the tape head 14. In an alternate example (not shown) the compression roller 28 is not included in the tape head 14 assembly and is a separate device that moves or generally tracks the tape head 14 or tape reel 20. In one example, the compression roller 28 is connected to and is moved by the actuator 16 (e.g., robot) or another actuator.

In the illustrated examples, the compression roller 28 is positioned downstream of the tape reel 20 and receives the tape 24 from the tape reel 20 along the tape path of travel 26.

In the FIG. 1 example, the taping device 10 is used in a tape winding application wherein the tape 24 is applied or wound around a mandrel 40. In the FIG. 1 example, the mandrel is a hollow cylindrically-shaped member rotatable about an axis 42. In the example, the mandrel 40 includes an outer wall 44 having an outer surface 46 and an inner surface 47 defining an interior cavity 50.

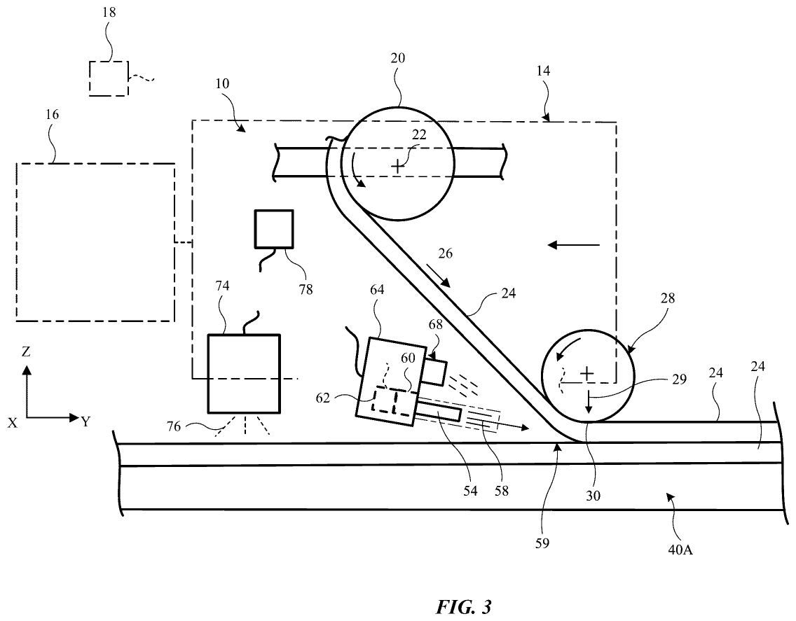

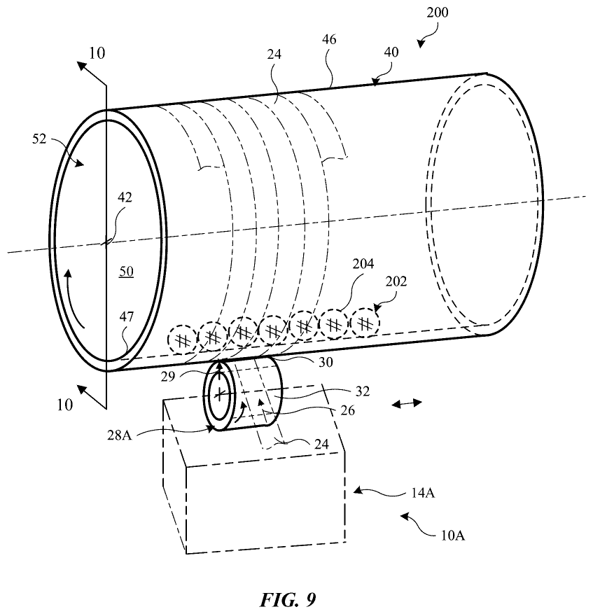

In one example, the mandrel 40 includes rounded ends (not shown) that converge toward the axis 42 and that are closed at both ends (i.e., a closed container). In an alternate example, the mandrel 40 includes an opening 52, for example an open end as generally shown in FIGS. 1 and 9, or alternately in the outer wall 44 (not shown) that is in communication with the interior cavity 50. In an alternate example, one or both of the rounded ends may include the opening 52. In one example, the mandrel 40 serves as a substrate or base part which forms a completed reinforced component on application of the tape 24 to the outer surface 46 of the mandrel 40. In one example, the mandrel 40 is formed of a semi-rigid polymer (e.g., plastic) that is suitable to bond or adhere (i.e., consolidate) to or with the tape 24 on application of heat to the mandrel 40 and/or the tape 24 as further described below. In one example shown in FIG. 3 and discussed further below, the mandrel 40A may be a planar or formed curved panel or substrate. It is understood that the mandrel 40, 40A (hereafter collectively referred simply as mandrel 40 unless otherwise noted) can take other forms, shapes, configurations, sizes, dimensions, geometric features, and materials based on the desired reinforced component to be manufactured as known by persons skilled in the art.

In the taping device 10 example in FIG. 1, the compression roller 28 is configured to apply the compressive force 29 to the tape 24 at the contact region 30 to consolidate (i.e., bond, adhere, join or connect) the tape 24 to the mandrel 40. In one example, the mandrel 40 is rotated by an actuator (not shown) about the axis 42 and the tape 24 is dispensed or fed from the tape reel 20 to the compression roller 28 along the tape path of travel 26 as generally illustrated. The compression roller 28 applies the compressive force 29 to the tape 24 positioned between the compression roller 28 and the mandrel 40 at the contact region 30. As further described below, the application of heat to the tape 24 and/or the mandrel 40, in combination with the compressive force 29, consolidates the tape 24 to the mandrel 40. The tape head 14 moves laterally in the X direction parallel to the axis 42 of the mandrel 40 to apply a layer of the tape 24 to and around the mandrel 40 in the areas or portions of the mandrel 40 as desired. In one example, a successive layer, or successive layers (i.e., multiple overlapping layers) of tape 24 may be applied over the first layer of tape previously consolidated to the mandrel 40 to achieve the desired strength or physical properties of the completed reinforced component.

Referring to the examples shown in FIGS. 1 and 4, the taping device 10 includes a nozzle 54 configured to direct a heated gas 58 into or onto an area 59 encompassing a portion of the tape path of travel 26 to heat the tape 24 and the interface between the tape 24 and the mandrel 40, or the interface between the tape 24 to be applied and a previously applied and consolidated layer of tape 24, prior to application of the compressive force 29 by the compression roller 28. In another example, the heated gas 58 is also directed to heat the mandrel 40 upstream of the compression roller 28 and the contact region 30 prior to the application of the compressive force 29 on the tape 24 to consolidate the tape 24 to the mandrel 40 or a previously consolidated or applied layer of tape 24.

In one example of the taping device 10, the heated gas 58 is nitrogen which provides advantages of increased temperature control of the heating source (i.e., the heated gas 58) and the reduction or elimination of oxidation of the tape 24 when the tape 24 is heated by the heated nitrogen gas prior to consolidation of the tape 24 by the compression roller 28. In alternate examples, the heated gas is helium or other inert gases which provide the advantage of reducing or eliminating oxidation of the tape 24 as noted. In the examples, the nitrogen gas, and other gases, are commercially available pure gas. It is understood that commercially available gasses may include certain other gases, impurities, and/or additives as well. In an alternate example, the heated gas 58 be a gas other than nitrogen, or other than inert gases, to suit the particular application and performance requirements as known by persons skilled in the art.

In one example as shown in the FIGS., a single nozzle is used. In an alternate example, two or more nozzles 54, or a plurality of nozzles 54, may be used to transfer or direct the heated gas 58 to heat the tape 24 and/or the mandrel 40. The nozzle 54 may be any commercially available nozzle suitable for the transfer of heated gas, for example nitrogen, helium or other inert gases, or other gases, and suitable for tape winding and tape laying processes consistent with the examples in this disclosure and as known by persons skilled in the art. In one example, the nozzle 54 is made from Inconel, although other materials may be used as known by persons skilled in the art.

In the illustrated examples, the nozzle 54, and the area 59 encompassing a portion of the tape path of travel 26, are positioned upstream of the contact region 30 in order to heat the tape 24 prior to application of the compressive force 29 to the tape 24.

As best seen in the FIG. 1 example, the taping device 10 includes a manifold 60 in gaseous communication with a pressurized gas source (not shown) and the nozzle 54 to provide the pressurized gas, for example nitrogen or other gases, to and through the nozzle 54. The manifold 60 serves to provide a reservoir of a volume of the pressurized gas and to direct the pressurized gas to the nozzle 54 (or multiple nozzles). In one example as shown in the FIGS., the manifold 60 is a part of, or a component of, the tape head 14 assembly. In an alternate example (not shown), the manifold 60 is a separate device from the tape head 14 which is configured to maintain gaseous communication between the manifold 60 and the nozzle 54. In one example, taping device 10 does not include a manifold 60 and the nozzle 54 is in gaseous communication with the pressurized gas source.

Still referring to the FIG. 1 example, the taping device 10 includes a heating element 62 in communication with the pressurized gas to generate the heated gas 58 used to heat the tape 24 as described herein. In one example, the heating element 62 is positioned in the manifold 60 to heat the pressurized gas in the manifold prior to the heated gas 58 entering the nozzle 54. In another example, the heating element 62 is positioned in the nozzle 54, for example a heating element coil positioned in a path of travel of the pressurized gas, whereby pressurized gas passing through the nozzle 54 is heated prior to exiting the nozzle 54. In an alternate example the heating element 62 is positioned upstream of the manifold 60 such that the pressurized gas is heated prior to entering the manifold 60. The heating element 62 may be positioned in an alternate location, for example internal to the tape head 14, or exterior to the tape head 14, to suit the particular application or performance requirements as known by persons skilled in the art.

In one example, the heating element 62 is an electric heating element connected to a power source, for example an electric power source which provides electricity to generate heat in the heating element 62. Other forms and configurations of heating element 62 suitable for heating pressurized gas to generate the heated gas 58 may be used as known by persons skilled in the art.

Still referring to the FIG. 1 example, the manifold 60 may include a housing 64 to enclose the manifold 60, and in the example shown, the heating element 62.

In one example, the tape 24 in the exemplary form of thermoplastic unidirectional tape includes a melting temperature (e.g., a transition temperature) wherein the tape 24 becomes or transitions into a state or condition wherein when placed under a compressive force, for example the compressive force 29, the tape 24 is capable of consolidating (i.e., bonding, adhering, joining) to the mandrel 40 or a previously applied and consolidated layer of tape 24. In one example, the heated gas 58, for example nitrogen, is heated by the heating element 62 to a temperature at or higher than the melting temperature of the tape 24, but below a temperature of 500 degrees Celsius (C) (932 degrees Fahrenheit) when the heated gas 58 exits the nozzle 54 or is positioned in the area 59. It is understood that the temperature of the heated gas 58 may be set and regulated during the process at a suitable temperature based on the application, for example the tape 24 that is being used and applied. It is understood the temperature of the heated gas 58 may be above or below the disclosed temperature range to suit the particular application and performance specifications as known by persons skilled in the art.

Still referring to the FIGS. 1 and 4 examples, the taping device 10 may include a shield 66 configured to direct and/or concentrate (i.e., at least partially enclose and/or partially or temporarily confine) the heated gas 58 in the area 59 encompassing the tape path of travel 26 wherein the tape 24 is heated by the heated gas 58. In one example, the shield 66 may be a round or four-sided, hollow, open-ended tube or box that axially extends beyond the nozzle 54 so as to direct and concentrate the heated gas 58 to the area 59 to heat the tape 24. By concentrating the heated gas 58, for example nitrogen, in the area 59 to heat the tape 24, advantages of efficiently heating the tape 24, and in the example that the heated gas 58 is nitrogen, reducing or eliminating oxidation of the tape 24 prior to consolidation by the compression roller 28 is achieved.

Alternate structures, configurations and positions of the shield 66 may be used, for example a two-sided shield having two open sides, or a three-sided shield having one open. In one example, the shield 66 may be a part of, or be connected to the nozzle 54. In one example, the shield 66 may be separate from the nozzle 54 and be a separate component as part of the tape head 14. In an alternate example, the shield 66 may be separate from the tape head 14 and be in the form of a separate enclosure or partial enclosure (not shown) in or around the area 59 encompassing the tape path of travel 26 to achieve the above noted advantages. The shield 66 may be made from steel or other materials suitable for exposure to the heated gas 58 as described herein. Other structures, forms, configurations, orientations, positions, and materials of the shield 66 may be used to suit the particular application, performance requirements, and/or to achieve the above advantages and other advantages, as known by persons skilled in the art.

Still referring to the FIG. 1 example, the taping device 10 include a sensor 68 configured to measure a temperature of the tape 24 in the area 59 encompassing the tape path of travel 26 wherein the tape 24 is heated by the heated gas 58, for example nitrogen gas. In one example, the sensor 68 is configured to detect and monitor the temperature of one or more, or all of, the heated gas 58 that has exited the nozzle 54, the tape 24 in the area 59, and/or the mandrel 40 upstream of the contact region 30 (e.g., in the area 59). In one example, the sensor 68 is a vision device 69, for example an infrared (IR) camera, that detects and monitors the temperature in one or more of the areas, or one or more of the components, as described.

In one example, the vision device 69, for example the IR camera, detects the temperature of the heated gas 58 exiting the nozzle 54 and the tape 24 in the area 59 to determine if the temperatures of the heated gas 58 and the tape 24 are within predetermined values or ranges of values suitable for the tape 24 being applied, and for proper consolidation of the tape 24 on application of the compressive force 29. In one example, the vision device (e.g., IR camera) sends signals to the control system 18 wherein images of the detected heat and temperatures can be seen on a visual monitor. Sensor 68, and vision device 69, may be other forms of sensors used to measure the described temperature(s) to suit the particular application and performance requirements as known by persons skilled in the art.

Still referring to the FIG. 1 example, the taping device 10 further includes a controller 78 shown as part of the tape head 14 assembly. In one example, the controller 78 is in communication with the control system 18 to receive signals from the control system 18 and send signals to the control system 18. In one example, the controller 78 is in communication with the manifold 60 to control and regulate the volume of flow of the pressurized gas from the pressurized gas source to the nozzle 54. In one example, the controller 78 is in communication with the heating element 62 to control and regulate energizing and de-energizing the heating element 62, for example providing electrical power to the heating element 62 to heat the heated gas 58 as described herein. In one example, the controller 78 is in communication with the sensor 68, for example the vision device 69 as described herein.

In one example, the controller 78 is in communication with one or more actuators (not shown) to, for example, actuate or power the tape reel 20 and/or the compression roller 28 to control and regulate the dispensing and application of the tape 24 to the mandrel 40. In one example, the tape head 14 may include one or more, or a plurality of, sensors which monitor the state or condition of various components of the tape head 14 or the taping device 10, and the controller 78 controls, monitors, and/or regulates the sensors. In one example, the taping device 10 does not include an controller 78 as part of the tape head 14 and relies on the control system 18 for the exemplary features and functions described for controller 78.

In one example of the taping device 10, the control system 18 receives the signals from the controller 78 in communication with the vision device (e.g., the IR camera), calculates the detected temperatures at predetermined areas (e.g., the heated gas 58, the tape 24 in the area 59, and/or the mandrel 40), compares the detected temperatures to predetermined temperatures values or ranges of values stored in memory for the particular application or tape 24, and automatically adjusts, or signals a technician or user to adjust, the described taping device 10 components to bring any detected temperatures that are outside of the predetermined values or ranges back within the predetermined values or ranges of values.

In one example, if the detected temperature of the tape 24 that is heated in the area 59 is below a predetermined value, the control system 18 can energize or increase the temperature of the heating element 62 to increase the temperature of the heated gas 58 to thereby increase the temperature of the tape 24 that is heated by the heated gas 58 in the area 59. In another example, the control system 18, in combination with the controller 78, may adjust and change the volume of flow of the pressurized gas exiting the nozzle 54 to heat the tape 24 in the area 59. The control system 18, and/or the controller 78, may control, regulate, and/or adjust other components, functions or aspects of the taping device 10 to ensure proper heating and consolidation or adhesion of tape 24 to the mandrel 40 or a previously applied layer of tape 24 to suit the particular application and performance requirements as known by persons skilled in the art.

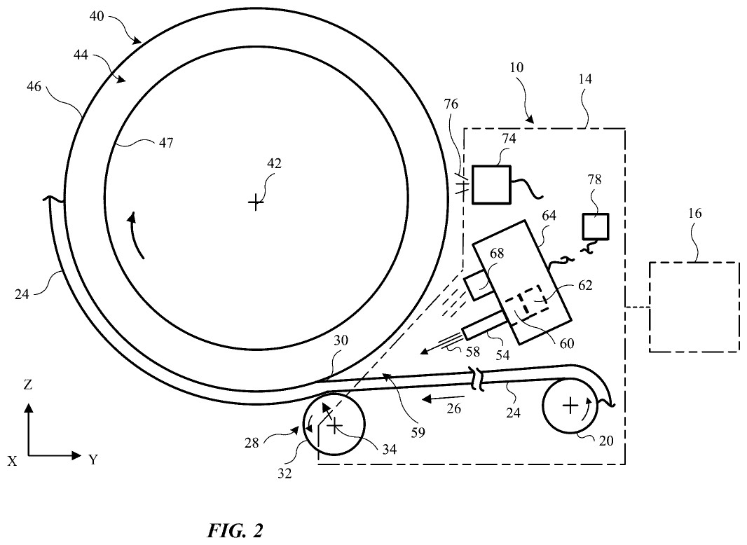

Still referring to the FIG. 1 example, and as also seen in the examples in FIGS. 2, 3, 5 and 5A, the taping device 10 includes a heater 74 positioned upstream of the contact region 30 and is configured to apply heat 76 to at least one of the mandrel 40, or a previously applied layer of tape 24 consolidated to the mandrel 40, prior to application of the compressive force 29 to the successive layer of tape 24 configured to be applied over the layer of tape 24 previously consolidated to the mandrel 40. In one example, the heater 74 is an infrared pre-heater thermistor that is positioned adjacent to the mandrel 40 and upstream of the nozzle 54 and the compression roller 28. In one example, the heater 74 applies the heat 76 to the mandrel 40, or a previously applied and consolidated layer of tape 24, to preheat the mandrel 40 or previously applied layer of tape 24, which in part, and in combination with the heated gas 58, heats the interface of the tape 24 and the mandrel 40 to ensure proper consolidation of the tape 24 that is heated by the heated gas 58 prior to application of the compressive force 29 by the compression roller 28.

In one example, the heater 74 is in communication with the controller 78 and/or the control system 18. In one example, the taping device 10 may include a sensor, for example the sensor 68, which measures the temperature of the mandrel 40 or previously applied layer of tape 24, to determine if the measured temperature is within a predetermined value or range of values. The controller 78 and/or the control system 18 may automatically adjust, or signal a technician or user to adjust, the heater 74 to raise or lower the heat 76 if the measured temperature is outside the predetermined temperature value or range of values.

In one example shown in FIGS. 1-3, 5 and 6, the heater 74 is connected to and forms a part of the tape head 14. In an alternate example (not shown), the heater 74 is not connected to or a part of the tape head 14 and is a separate component positioned in the workstation to apply heat to the mandrel 40 or a previously applied and consolidated layer of tape 24 as described. Other forms or devices of heater 74, and positions, orientations and uses of the heater 74, may be used to suit the particular application or performance requirements as known by persons skilled in the art.

Referring to FIG. 2, an alternate example of the FIG. 1 taping device 10 in an example tape winding application is shown. In the FIGS., the same or substantially similar components include the same element reference numbers. In the FIG. 2 example, the tape head 14 and the compression roller 28 are positioned and oriented relative to the mandrel 40 such that the compression roller 28 and the nozzle 54 are positioned toward a bottom or vertically lower along the Z axis portion of the mandrel 40. In this tape head 14 or compression roller 28 position, the nozzle 54 and expulsion of the heated gas 58 has an advantage that the heated gas 58 naturally rises in the vertical or Z direction which assists in preheating the mandrel 40 or a previously applied and consolidated layer of tape 24 upstream of the area 59 and the contact region 30. It is understood that the position and orientation of the tape head 14, the nozzle 54, and/or the compression roller 28 can take alternate positions and orientations relative to the mandrel 40 to suit the particular application and performance specification as known by persons skilled in the art.

Referring to FIG. 3, an example of the taping device 10 described for FIG. 1 in an example tape laying or tape lamination application is shown. In the FIG. 3 example, the mandrel 40A is a planar panel, for example a preformed, semi-rigid panel. As described above, the mandrel 40A in a tape laying application may be a generally flat or planar panel or substrate, or may include curves or complex geometric formations and surfaces (not shown). In one application, the mandrel 40A is stationary relative to the workstation and the tape head 14 moves relative to the mandrel 40A. It is understood that the mandrel 40A can take any form or configuration that is suitable for a tape laying or lamination process as known by persons skilled in the art. In alternate tape laying applications and use of taping device 10, the mandrel 40A may move relative to the workstation or taping device 10.

In the FIG. 3 example, the tape head 14, the tape reel 20, and/or compression roller 28 may move as a unit or assembly along the surface of mandrel 40A (shown moving to the left along the Y direction in FIG. 3), to dispense the tape 24 along the tape path of travel 26. The tape head 14, the tape reel 20, and/or compression roller 28 may be caused by the actuator 16 (e.g., robot) to change direction, for example in the X and/or Z directions) and/or orientation relative to the mandrel 40A to apply and consolidate tape 24 to the mandrel 40A or a previously applied and consolidated layer of tape 24 as desired for the intended manufactured component (one layer of previously applied and consolidated tape 24 shown in FIG. 3). Sensors (not shown) connected to the tape head 14 may be in communication with the control system 18 in a closed-loop feedback system to monitor the position of the tape head 14, and other components, for example the tape reel 20 and or the compression roller 28, to monitor the length and/or amount of tape 24 that is being dispensed and applied.

In the FIG. 3 example, the heater 74 is used to preheat the mandrel 40A, and/or the previously applied and consolidated layer of tape 24 upstream of the contact region 30 as generally described for FIG. 1. The tape 24 is heated by the heated gas 58 in the area 59 upstream of the contact region 30 and prior to application of the compressive force 29 by the compression roller 28 as generally described for FIG. 1. It is understood that the taping device 10 may be used for other taping applications other than tape winding and tape laying, or variations of tape winding and tape laying other than those illustrated and generally described, as known by persons skilled in the art.

Referring to FIG. 4, a schematic illustration of an example of the tape 24 in the form of a unidirectional tape and an area 59 encompassing a portion of the tape path of travel 26 upstream of the contact region 30 wherein the unidirectional tape is heated by the heated gas 58 prior to application of the compressive force 29 by the compression roller 28. In one example, the unidirectional tape is thermoplastic unidirectional tape.

In the FIG. 4 example, the unidirectional tape includes a width 84 transverse to the tape path of travel 26 and the reinforcing fibers 25 are oriented parallel to the tape path of travel 26. Presently, commercially available thermoplastic unidirectional tapes are commonly available in 0.25 inches in width, 0.5 inches in width, and 1.0 inches in width. It is understood that the taping device 10 may be used for unidirectional tapes having wider and narrower widths.

In the example, the area 59 encompassing the tape path of travel 26 to heat the unidirectional tape has an area width 86 transverse to the tape path of travel 26 and an area length 88 parallel to the tape path of travel 26 as generally shown. In the example, the nozzle 54 is positioned and oriented to direct the heated gas 58 into, onto, and/or over the area 59 to effectively cover the area 59 defined by the area width 86 and the area length 88 which the width 84 of the unidirectional tape passes through along the tape path of travel 26. In one example, the area width 86 is 5-10 millimeters (mm) wider than the width 84 of the unidirectional tape to ensure that the entire width of the tape 24 is exposed to the heated gas 58 as the tape 24 moves along the tape path of travel 26. In one example where the heated gas 58 is nitrogen, complete exposure or coverage of the tape 24 with the nitrogen gas ensures proper heating of the tape 24 and the advantage of reducing or eliminating oxidation of the tape 24 prior to application of the compressive force 29 and consolidation of the tape 24.

In one example, the area length 88 is 10-20 millimeters of the tape 24 along the tape path of travel 26 as generally shown. The disclosed area width 86 and area length 88 examples provide a focused area for the heated gas 58 to be directed or dispersed for proper heating of the tape 24 and efficient use of the pressurized gas that is heated to form the heated gas 58 as described herein. As noted above, although only one nozzle 54 is shown in the illustrations, two or more, or a plurality of, nozzles 54 may be used. As also noted above, the shield 66 may be used to direct and/or concentrate the heated gas 58 into or over the area 59. It is understood that the area 59, the area width 86, and the area length 88, may vary, both in greater or lesser values, depending on the application, the tape 24 used for the application, and the performance requirements as understood by those skilled in the art.

Referring to FIGS. 5, 6 and 7, examples of the tape head 14 useful in the taping device 10 and the applications described herein are shown. Referring to FIG. 5, an example of the tape head 14 useful in a tape laying or lamination application, for example schematically shown in FIG. 3, is illustrated. In the example, the tape head 14 includes a frame 90 having a mounting plate 92 and a mount 94 connected thereto. In one example, the actuator 16 (e.g., robot wrist or end effector) is connected to the mount 94 to move and orient the tape head 14 and the taping device 10 relative to the mandrel 40A.

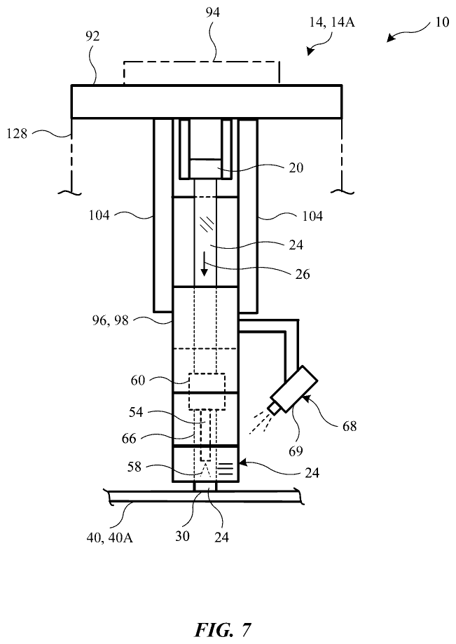

The frame 90 example further includes a base 96 having a first end 98 and a second end 100. In the example, the first end 98 is positioned downstream or is the trailing end of the tape head 14 and supports the compression roller 28 as generally shown. The base 96 defines a through bore 102 which provides a pathway for the tape 24 to pass through the through bore 102 along the tape path of travel 26 toward the compression roller 28. As best seen in FIGS. 5 and 7, the frame 90 further includes two side plates 104 that connect the base 96 to the mounting plate 92 as generally shown.

The FIG. 5 frame 90 example further includes a guide beam 108 that includes a first end 110 and a second end 112. The guide beam 108 is pivotally mounted to the base 96 and rotates about an axis 114. In the example, a guide roller 116 is rotatably connected to a distal end of the first end 110 and rotates about an axis 118. In one example, the guide roller 116 rollingly engages the mandrel 40A or a previously applied and consolidated layer of tape 24 positioned on the mandrel 40A. In one example, the guide roller 116 includes a radial central groove or formation on an outer perimeter of the contact surface (not shown) which supports and abuttingly engages the nozzle 54 to position and orient the nozzle 54 to direct the heated gas 58 toward the area 59 encompassing the tape path of travel 26 as described above. It is understood that a structure or device other than the guide roller 116 may be used to support and orient the nozzle 54. In an alternate example, the guide roller 116 is omitted or otherwise does not support and orient the nozzle 54 (i.e., the nozzle 54 is self-supporting and directing on the guide beam 108 or the frame 90).

In the frame 90 example as shown, the guide beam 108 also supports and secures the manifold 60 and the heating element 62. It is understood that the manifold 60 and/or the heating element 62 may be positioned and supported by another portion of the frame 90.

In the FIG. 5 example, the frame 90 includes a first link 120 and a second link 122. The first link 120 is positioned between and connected to the mounting plate 92 and the second end 112 of the guide beam 108. The second link 122 is positioned between and connected to the second end 112 of the guide beam 108 and the second end 100 of the base 96. In one example of the tape head 14, the first link 120 and the second link 122 are configured as opposing biasing members to provide a resistance force against movement of the guide beam 108 about the axis 114 to generate a compressive force by the guide roller 116 to the mandrel 40A. The compressive force by the guide roller 116 serves to keep the guide roller 116 in contact with the mandrel 40A to ensure that the nozzle 54 is properly positioned and oriented relative to the mandrel 40A to direct the heated gas 58 to the area 59 to heat the tape 24 and the interface between the tape 24 and the mandrel 40A to properly heat the tape 24 and the interface for proper consolidation of the tape 24 as described herein.

In one example, the first link 120 and the second link are complimentary biasing members, for example springs which provide a resistance force to an axial compression (i.e., axial shortening of the spring) or axial tension (i.e., axial lengthening of the spring). In one example, as the guide roller 116 is caused to move up and down in the Z direction, for example to accommodate curves or geometric formations in the mandrel 40A, the guide beam 108 is rotated about the axis 114. The second end 112 of the guide beam 108 is resisted from movement by the opposing first link 120 and the second link 122, and a downward compressive force is applied by the guide roller 116 to keep the guide roller 116 in contact with the mandrel 40A and the nozzle 54 properly positioned and oriented as described.

It is understood that the first link 120 and the second link 122 may take other forms and configurations to apply the resistance to movement of the second end 100 of the guide beam 108 and the compressive force of the guide roller 116 on the mandrel 40A. In one example, only a single link, either the first link 120 or the second link 122 may be used. In an alternate example, the first link 120 and the second link 122 may be other mechanical devices, for example, cams, gears, pneumatic or hydraulic pistons, ball screws, ball spline screws, and other devices known by those skilled in the art. In alternate examples, actuators (not shown) may be connected to one or more of the first link 120 or the second link 122 to actively monitor and control the position of the second end 100 of the guide beam 108 and the resultant compressive force applied by the guide roller 116 on the mandrel 40A. One or more sensors (not shown) in communication with the controller 78 or control system 18 may be used to monitor and regulate the position of the second end 100 of the guide beam 108 and the compressive force applied by the guide roller 116.

In the FIG. 5 example and as best seen in FIG. 7, the sensor 68, for example the vision device 69 in the form of the IR camera, is connected to the base 96 to position the sensor 68 to monitor the temperature(s) as described above. In the FIG. 5 example, the heater 74 is connected to the second end 100 of the base by a support 124 to position the heater 74 to project the heat 76 to heat the mandrel 40A or a previously applied and consolidated layer of tape 24 upstream of the contact region 30 as described.

Referring to FIG. 6, an alternate example of the tape head 14A for use with the taping device 10 in a tape winding application schematically shown in FIGS. 1 and 2 is illustrated. In the example, the same or substantially similar components include the same reference numbers and include the features and functions described for FIG. 6 and the taping device 10 described herein. In the example, the support 124A for the heater is moved toward the guide beam 108 and the heater 74 is rotatable about an axis 126 to angularly orient the heater 74 toward the mandrel 40 to account for the curved surface of the mandrel 40 to more evenly direct and apply the heat 76 to the outer surface 46 of the mandrel 40.

In the examples shown in FIGS. 1, 5 and 7, the tape head 14 may include a frame housing 128 to cover at least a portion of the frame 90 and the internal components of the tape head 14 as described or illustrated herein. The frame housing 128 may be used on any of the tape head 14 examples and the taping device 10 examples described or illustrated.

In one example for FIGS. 5 and 6, the frame 90 is made from steel, non-ferrous metal, for example aluminum, composite materials, or other materials known by persons skilled in the art. It is understood that the tape head 14, 14A, and the associated frame 90, can take other configurations, structures, constructions, sizes, shapes, and orientations to suit the particular application and performance requirements as known by persons skilled in the art.

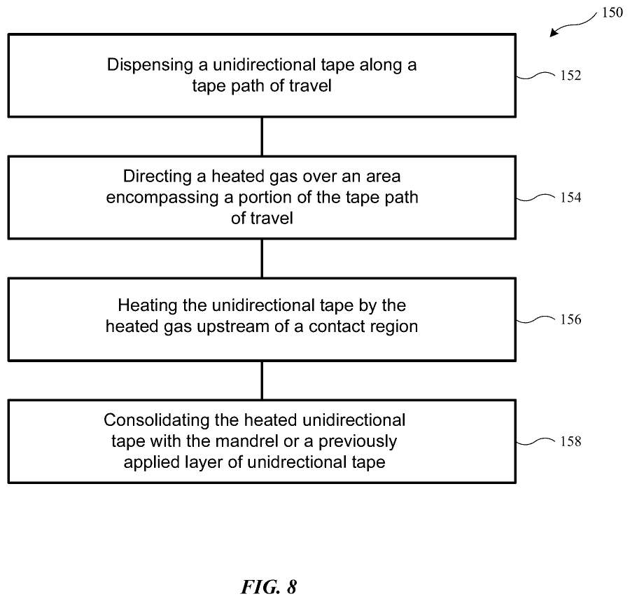

Referring to FIG. 8, a schematic flow chart of a method of consolidating a unidirectional tape 150 is shown. In one example, unidirectional tape includes tape 24 as described above. In one example, the unidirectional tape includes the reinforcing fibers 25 as described above and schematically illustrated in FIG. 4. In one example, the unidirectional tape is thermoplastic unidirectional tape as described above.

An example of step 152 includes dispensing the unidirectional tape, for example the tape 24 in the form of unidirectional tape as described above, along a tape path of travel, for example tape path of travel 26, described above. In one example, the unidirectional tape is supported and dispensed by a tape reel 20 described above. In one example, the tape reel 20 is a component of the tape head 14. In one example, the tape head 14 is configured as tape head 14 or 14A described above and shown in FIGS. 5 and 6, respectively. Alternate structures and devices for dispensing the unidirectional tape may be used as known by persons skilled in the art.

An example of step 154 includes directing a heated gas over an area encompassing a portion of the tape path of travel upstream of a compression roller having a contact region with a mandrel. In one example, the heated gas is the heated gas 58, the area is 59, the tape path of travel is tape path of travel 26, the compression roller is compression roller 28, the contact region is contact region 30, and the mandrel is mandrel 40, 40A as described in the examples above and shown in the illustrations.

In one example, the pressurized gas is heated by a heating element 62 to a temperature at or above the melting temperature of the unidirectional tape and below 500 degrees Celsius (C) and directed by a nozzle 54 to an area 59 to heat the tape 24 by the heated gas 58 as described in the above examples. In one example, the heated gas 58 is nitrogen gas and the unidirectional tape is thermoplastic unidirectional tape having a melting temperature. The heated gas 58, for example nitrogen gas, is heated to a temperature of at least the melting temperature of the thermoplastic unidirectional tape. In one example, the pressurized gas is heated by a heating element 62 as described above and shown in the illustrations. As described above, alternate gases, alternate tapes, and alternate unidirectional tapes may be used.

An example of step 156 includes heating the unidirectional tape by the heated gas 58 in the area 59 encompassing the portion of the tape path of travel 26 upstream of the contact region 30.

An example of step 158 includes consolidating the unidirectional tape with the mandrel 40, 40A or a layer of unidirectional tape previously consolidated with the mandrel 40, 40A by applying a compressive force 29 at the contact region 30 by the compression roller 28 on the unidirectional tape heated by the heated gas 58 in the area 59 encompassing a portion of the tape path of travel 26 as described in the examples and illustrations above.

In one example of step 154, the heated gas 58 is concentrated in the area 59 by a shield 66 as described in the examples above.

In one example of step 156, the unidirectional tape includes a width 84 transverse to the tape path of travel 26. The method step further includes directing the heated gas 58, for example nitrogen, to the area 59 encompassing the portion of the tape path of travel 26. In one example, the area 59 has an area width 86 and an area length 88 described above and illustrated in FIG. 4. In one example, the area width 86 is 5-10 millimeters (mm) wider than the width 84 of the unidirectional tape and the area length 88 is 10-20 millimeters (mm) to heat the unidirectional tape and the interface as described above. Area 59 may include alternate locations, and consist of an alternately sized and oriented area width 86 and area length 88 as described above.

One optional step (not shown), includes heating at least one of the mandrel or a layer of unidirectional tape, for example thermoplastic unidirectional tape, previously applied and consolidated with the mandrel. In one example, a heater 74 is used to apply heat 76 to the mandrel 40, 40A or a previously applied layer of tape 24 or unidirectional tape. Heating by heater 74 occurs upstream of the nozzle 54 and prior to the application of the compressive force 29 to a successive layer of unidirectional tape, for example thermoplastic unidirectional tape, that is to be applied and consolidated to the mandrel 40, 40A or the previously applied layer of tape 24 as described above.

In one optional step (not shown), a control system 18 is configured to control at least one of the dispensing of the unidirectional tape, the directing of the heated gas 58 over the area 59, the heating of the unidirectional tape by the heated gas 58, and/or consolidating the unidirectional tape as describe above. In one example, the taping device 10 may include a sensor 68 in the form of an infrared camera configured to measure the temperature of the heated tape and area 59 as described above. In one example, the control system 18 may include a controller 78 as part of the tape head 14. In examples described above, the control system 18, in one example through communication with the controller 78, is in communication with the at least one of, and in one example all of, the manifold 60, the heating element 62, the sensor 68, and the heater 74 for monitoring, controlling and regulating the pressurized gas generating the heated gas 58, the temperatures of the tape 24 and mandrel 40, 40A, and a tension force on the tape 24.

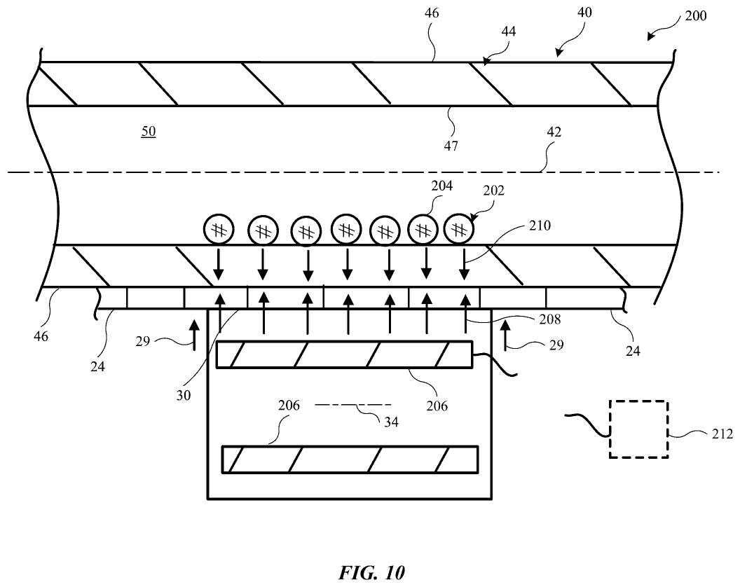

Referring to FIGS. 9 and 10, an example of a taping device 10A for use with a compression compensation device 200 (further described below) is shown. In one example, the taping device 10A includes a tape head 14A including the components, features and functions described above for the tape head 14 and the taping device 10.

It is understood that the individual components, and their respective features and functions, described for taping device 10 may be used individually or in any combination with one another without requiring the other components and their respective features and functions described above in the various examples as known by persons skilled in the art. It is understood that additional method steps of method for consolidating unidirectional tape 150 may be used using the elements and functions described above for taping device 10, or the methods steps may be executed in a different order than described and illustrated as known by persons skilled in art.

Referring to FIGS. 9 and 10, an example of a compression compensation device 200 for use in a taping process or application is shown. In one example, the taping application may include the tape winding application described above for taping device 10. In one example, the taping device 10 is used with the compression compensation device 200. The compression compensation device 200 may also be used in other applications, including alternate taping applications, where a tape 24 or other reinforcement material is applied to the mandrel 40 that is hollow and a compression roller 28 is used to apply a compressive force 29 on the mandrel 40. In the FIGS. 9 and 10 example, the same element reference numbers are used for the same or substantially the same components as described above for taping device 10.

In the FIGS. 9 and 10 example, the compression compensation device 200 is useful with a mandrel 40 having the outer wall 44 including the outer surface 46 and the inner surface 47 defining an interior cavity 50 as generally described above as useful for the taping device 10 in a tape winding application (e.g., schematically shown in FIGS. 1 and 2). In one example, the mandrel 40 includes an opening 52 in the outer wall 44 in communication with the interior cavity 50. The opening 52 may be an open end of the mandrel 40, for example in a mandrel 40 that has rounded or partially closed ends (not shown), or may be in the outer wall 44 in communication with the interior cavity 50 as described above.

In conventional tape winding applications, a compression roller may apply a compressive force (e.g., compressive force 29) between 10-300 Newtons (N) (2.25-67.4 pound-force (lbf.)) to the outer surface 46 of the mandrel 40. Depending on the physical geometric features of the mandrel 40, for example thickness of the outer wall 44, and the material that the mandrel 40 is made from, the compressive force applied may bend or distort the geometry of the mandrel 40 which may affect the tape winding application and ultimately the success of the intended final manufactured product. An objective of the compression compensation device 200 is to at least partially reduce or counteract the compressive force 29 and reduce potential bending or distortion of the mandrel 40 during the taping process and improve the intended final manufactured product.

In one example of the compression compensation device 200, a compression element 202 is positioned in the interior cavity 50 in abutting contact with the inner surface 47 of the outer wall 44. In one example, the compression element 202 includes a ferrous material that is attracted by a magnet or other device. In one example, the compression element 202 includes one or more, or a plurality, of balls 204 (seven shown) each including the ferrous material. In one example, the balls 204 are spherical-shaped and made from the ferrous material that is attracted by a magnet 206 discussed further below. It is understood that a greater number or a lesser number of balls 204 may be used to suit the particular application and compression compensation required as known by persons skilled in the art.

In an alternate example (not shown), the compression element 202 may take an alternate form or quantity, for example one or more, or a plurality, of elongate cylindrical rods or tubes which extend parallel to the axis 42 of the mandrel 40 and are made from the ferrous material that is attracted by the magnet 206. Other forms, configurations, quantities and materials may be used for the compression element 202 to suit the particular application and performance requirements as known by persons skilled in the art.

In one example, the compression element 202 is positioned in the interior cavity 50 through the opening 52 such that the compression element is in abutting contact with the inner surface 47 and will remain in the interior cavity 50 during rotation of the mandrel 40 about the axis 42.

In the FIGS. 9 and 10 example, the compression compensation device 200 includes a compression roller 28A configured to apply the compressive force 29 on the outer surface 46 of the outer wall 44 of the mandrel 40.

In the example as best seen in FIG. 10, the compression roller 28A includes the magnet 206 in magnetic communication with the compression element 202. The magnet 206 is configured to apply a magnetic attractive force 208 to the compression element 202 generating a reaction compressive force 210 by the compression element 202 on the inner surface 47 of the outer wall 44 to counteract at least a portion of the compressive force 29 of the compression roller 28A on the outer surface 46 of the outer wall 44 of the mandrel 40.

In one example, the magnet 206 is connected to the compression roller 28A. In the example shown, the magnet 206 is positioned in an interior of the compression roller 28A and radially adjacent to an outer wall or outer surface of the compression roller 28A. The magnet 206 is in magnetic communication with the compression element 202. The magnet 206 is configured to apply the magnetic attractive force 208 to the compression element 202. Due to the compression element 202 including ferrous material, the magnetic attractive force 208 of the magnet 206 generates the reaction compressive force 210 by the compression element 202 on the inner surface 47 of the outer wall 44 of the mandrel 40. The reaction compressive force 210 applied by the compression element 202 counteracts at least a portion of the compressive force 29 of the compression roller 28A on the outer surface 46 of the outer wall 44 of the mandrel 40. The reaction compressive force 210 at least partially offsets or balances the compressive force 29 applied by the compression roller 28A to reduce or eliminate deformation of the mandrel 40 that may be caused by the compressive force 29 by the compression roller 28A.

In one example of the compression compensation device 200, the magnet 206 is an electromagnet that is connected to an electrical power source 212 and is selectively energized to generate the magnet attractive force 208. In an alternate example, the magnet 206 may be a permanent magnet. It is understood that the magnet 206 can take other forms of magnets, or other devices capable to generate the magnetic attractive force 208, or other attractive force, and the reaction compression force 210 as described. It is understood that magnet 206 may take other forms, configurations, quantities, and positions relative to the compression roller 28A and the outer wall 44 of the mandrel 40, as known by persons skilled in the art.

An advantage of the compression element 202 in the form of balls 204, or other described configurations, is that the compression element 202 may be installed in the interior cavity 50 of the mandrel 40 through the opening 52 and used during the taping winding or other manufacturing process. When the tape winding process is completed, the compression element 202 may be removed through the opening 52 prior to final completion of the manufactured part.

While the invention has been described in connection with what is presently considered to be the most practical and preferred examples, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A taping device comprising:
a tape reel configured to dispense a tape;
a compression roller positioned downstream of the tape reel, the compression roller is configured to apply a compressive force to the tape at a contact region to consolidate the tape to a mandrel; and
a nozzle configured to direct a heated gas into an area encompassing a portion of a tape path of travel upstream of the contact region to heat the tape prior to application of the compressive force.

2. The taping device of claim 1, wherein the tape comprises unidirectional tape having reinforcing fibers embedded in the tape and oriented parallel to the tape path of travel.

3. The taping device of claim 2, wherein the unidirectional tape comprises thermoplastic unidirectional tape.

4. The taping device of claim 3, wherein the heated gas comprises nitrogen gas.

5. The taping device of claim 4, wherein the unidirectional tape includes a width transverse to the tape path of travel, and the area of the heated gas encompassing the tape path of travel to heat the tape has and an area width transverse to the tape path of travel and an area length parallel to the tape path of travel, wherein the area width is 5-10 millimeters (mm) wider than the width of the unidirectional tape and the area length is 10-20 millimeters (mm).

6. The taping device of claim 1, wherein the heated gas comprises nitrogen gas.

7. The taping device of claim 6, wherein the tape has a melting temperature, the nitrogen gas having a temperature above the melting temperature of the tape and below 500 degrees Celsius (C).

8. The taping device of claim 6, wherein the device further comprises a shield configured to concentrate the nitrogen gas in the area encompassing the tape path of travel wherein the tape is heated by the nitrogen gas.

9. The taping device of claim 6, wherein the tape comprises a thermoplastic unidirectional tape having a width transverse to the tape path of travel and reinforcing fibers oriented parallel to the tape path of travel.

10. The taping device of claim 9, wherein the area encompassing the tape path of travel to heat the unidirectional tape has and an area width transverse to the tape path of travel and an area length parallel to the tape path of travel, wherein the area width is 5-10 millimeters (mm) wider than the width of the unidirectional tape and the area length is 10-20 millimeters (mm).

11. The taping device of claim 6, further comprising:
a sensor configured to measure a temperature of the tape in the area encompassing the tape path of travel wherein the tape is heated by the nitrogen gas.

12. The taping device of claim 1, further comprising:
a heater positioned upstream of the contact region configured to heat at least one of the mandrel or a layer of the tape consolidated to the mandrel prior to application of the compressive force to a successive layer of the tape configured to be applied over the layer of tape previously consolidated to the mandrel.

13. The taping device of claim 1, wherein the mandrel comprises an outer wall having an outer surface and inner surface defining an interior cavity and an opening in the outer wall in communication with the interior cavity, the device further comprising:
a compression element positioned in the interior cavity in abutting contact with the inner surface of the mandrel, the compression element including a ferrous material; and
the compression roller further comprising a magnet in magnetic communication with the compression element, the magnet configured to apply a magnetic attractive force to the compression element generating a reaction compressive force by the compression element on the inner surface of the outer wall to counteract at least a portion of the compressive force of the compression roller on the outer surface of the outer wall of the mandrel.

14. The taping device of claim 13, wherein the compression element comprises a plurality of balls each including the ferrous material.

15. A unidirectional taping device comprising:
a tape reel configured to dispense a thermoplastic unidirectional tape having a width and including reinforcing fibers embedded in the thermoplastic unidirectional tape oriented parallel to a tape path of travel;
a compression roller positioned downstream of the tape reel along the tape path of travel, the compression roller is configured to apply a compressive force to the tape at a contact region to consolidate the tape with a mandrel;
a nozzle configured to direct heated gas into an area encompassing a portion of the tape path of travel upstream of the contact region to heat the tape prior to application of the compressive force, the area encompassing the tape path of travel including an area width 5-10 millimeters (mm) wider than the width of the thermoplastic unidirectional tape and an area length of 10-20 millimeters (mm);
a shield configured to concentrate the heated gas in the area width and the area length; and
a heater positioned upstream of the contact region configured to heat at least one of the mandrel prior to application of the compressive force to the thermoplastic unidirectional tape at the contact region or a layer of the thermoplastic unidirectional tape previously consolidated with the mandrel prior to application of the compressive force to a successive layer of the thermoplastic unidirectional tape received from the tape reel and configured to be applied over the layer of thermoplastic unidirectional tape previously consolidated with the mandrel.

16. The unidirectional taping device of claim 15, wherein the heated gas comprises nitrogen gas.

17. A method of consolidating a unidirectional tape, the method comprising:
dispensing the unidirectional tape along a tape path of travel;
directing a heated gas over an area encompassing a portion of the tape path of travel upstream of a compression roller having a contact region with a mandrel;
heating the unidirectional tape by the heated gas in the area encompassing the portion of the tape path of travel upstream of the contact region; and
consolidating the unidirectional tape with the mandrel or a layer of unidirectional tape previously consolidated with the mandrel by applying a compressive force at the contact region by the compression roller on the unidirectional tape heated by the heated gas in the area encompassing a portion of the tape path of travel.

18. The method of claim 17, wherein the heated gas comprises nitrogen gas and the unidirectional tape is a thermoplastic unidirectional tape having a melting temperature, the method further comprising:
heating the nitrogen gas to a temperature of at least the melting temperature of the thermoplastic unidirectional tape.

19. The method of claim 18, wherein the unidirectional tape includes a width transverse to the tape path of travel, and the area encompassing the portion of the path of travel has an area width transverse to the tape path of travel and an area length parallel to the tape path of travel, wherein directing the nitrogen gas further comprises:
directing the nitrogen gas to the area width of 5-10 millimeters (mm) wider than the width of the unidirectional tape and to the area length of 10-20 millimeters (mm) to heat the unidirectional tape.

20. The method of claim 18, further comprising:
heating at least one of the mandrel or the layer of thermoplastic unidirectional tape previously consolidated with the mandrel prior to the application of the compressive force to a successive layer of thermoplastic unidirectional tape that is heated by the nitrogen gas and configured to be applied over the layer of thermoplastic unidirectional tape previously consolidated with the mandrel.
